(19) United States
(12) Patent Application Publication
(10) Pub. No.: US 2018/0176774 A1
(43) Pub. Date: Jun. 21, 2018

(54) System and Method for Ensuring Secure Connections

(71) Applicant: John Miller, Oceanside, CA (US)

(72) Inventor: John Miller, Oceanside, CA (US)

(21) Appl. No.: 15/384,198

(22) Filed: Dec. 19, 2016

(51) Int. Cl. H04W 12/06; H04W 8/22; G06F 21/45; H04L 29/06; H04W 12/08

(52) U.S. Cl. CPC H04W 12/06; H04W 8/22; G06F 21/45; H04W 12/08; H04L 63/0823; H04L 63/0876; H04L 63/107; H04L 63/083

(57) ABSTRACT

A system and method for ensuring secure connections utilizing a mobile device that connects to a network or other device by using wired or wireless connectivity, a computer-implemented algorithm that is downloaded and installed onto the mobile device and is utilized to create a user account, and gathers the mobile device's identifying information; an edge device that is connected to an internet service provider; and a controller having a controller memory and a central processing unit that stores the user account, the edge device's information and contains a certificate authority that generates encrypted certificates using the mobile device's identifying information.

### BACKGROUND OF THE INVENTION

### 1. Field of the Invention

The present invention relates to the field of wireless network security. More specifically, the present invention allows a user to ensure a trusted connection over any wired or wireless access point.

### 2. Description of Related Art

Wireless edge devices are ubiquitous in today's digital world. Businesses often provide free wireless Internet to their customers to increase patronage. Private individuals often access the Internet through wired or wireless networks such as an Ethernet connection or Wi-Fi at home to simplify the connectivity of their home devices and to allow guests to access the Internet. With this increased availability and dependence on wireless networks, the likelihood for unauthorized use also increases.

Hackers are unauthorized users who surreptitiously gather information for unlawful purposes. Hackers often target personal information such as credit card numbers to make unauthorized purchases over the Internet. Hackers also target other personal information that would allow the hacker to open a credit card in the victim's name. Tracking and catching hackers is difficult because the hacker can be located anywhere in the world.

One way a hacker gains access to personal information is to “spoof” a wireless access point. A spoofing attack is when a malicious party impersonates another device or user on a network in order to launch attacks against network hosts, steal data, spread malware or bypass access controls. There are several different types of spoofing attacks that malicious parties can use to accomplish this. Some of the most common methods include Internet protocol (“IP”) address spoofing attacks and Address Resolution Protocol (“ARP”) spoofing attacks.

IP address spoofing is one of the most frequently used spoofing attack methods. In an IP address spoofing attack, an attacker sends IP packets from a false (or “spoofed”) source address in order to disguise itself. Denial-of-service attacks often use IP spoofing to overload networks and devices with packets that appear to be from legitimate source IP addresses.

ARP is a protocol that is used to resolve IP addresses to Media Access Control (“MAC”) addresses for transmitting data. In an ARP spoofing attack, a malicious party sends spoofed ARP messages across a local area network (“LAN”) in order to link the attacker's MAC address with the IP address of a legitimate member of the network. This type of spoofing attack results in data that is intended for the host's IP address getting sent to the attacker instead. Malicious parties commonly use ARP spoofing to steal information, modify data in-transit or stop traffic on a LAN. That is, the data containing personal information is routed through the attacker's network and the hacker gains access to all of the personal information. The victim often does not know that their information is being taken because their Internet access appears ordinary.

Currently, several techniques are used to prevent spoofing. One method is packet filtering where packets of information are inspected as they are transmitted across a network and are capable of filtering out and blocking packets with conflicting source address information. Another method is for a network administrator to avoid trust relationships between devices but this encumbers network flexibility because additional authentication methods are required. Another method is to use spoof-detecting software that helps detect spoofing attacks. But this requires a network administrator to purchase, employ, and maintain costly software. Another method is to use a cryptographic network protocol such as Transport Layer Security (“TLS”), Secure Shell (“SSL”), or Secure Hyper Text Transfer Protocol (“HTTPS”) that bolsters spoofing attack prevention efforts by encrypting data before it is sent and authenticating data as it is received.

Existing technology is effective at mitigating attacks on devices that are permanently connected to a network. But current methods are ineffective at mitigating attacks on roving devices; i.e., those that connect, disconnect, and reconnect to the same network or those that frequently connect to different networks. For example, current technologies are effective at mitigating attacks for a desktop computer that is connected to a network using a cable. Conversely, current technologies are ineffective at preventing attacks on a mobile phone that connects to various Wi-Fi networks. Further, current technology requires the administrator of the wireless network to employ security measures. Current technology does not allow an individual desiring to use a public Wi-Fi the ability to ensure that the wireless access point is legitimate.

Based on the foregoing, there is a need in the art for a method and system that allows a roaming mobile device to securely connect to any network while ensuring that the edge device is trusted.

### SUMMARY OF THE INVENTION

The present disclosure is directed at a system and method for ensuring secure connections utilizing a mobile device that connects to a network or other device by using wired or wireless connectivity, a computer-implemented algorithm that is downloaded and installed onto the mobile device and is utilized to create a user account, and gathers the mobile device's identifying information; an edge device that is connected to an internet service provider; and a controller having a controller memory and a central processing unit that stores the user account, the edge device's information and contains a certificate authority that generates encrypted certificates using the mobile device's identifying information.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an exemplary diagram depicting the system for ensuring secure connections between mobile devices and edge devices utilizing a cloud-based subscription and certificate authority, according to an embodiment of the present invention.

FIG. 2 is an exemplary diagram depicting the system for ensuring secure connections between mobile devices and edge devices utilizing an on-site subscription and certificate authority, according to an embodiment of the present invention.

FIG. 3 is an exemplary diagram depicting the system for ensuring secure connections between mobile devices and edge devices utilizing a cloud-based subscription and certificate authority as used in a home network environment and an Internet of things, according to an embodiment of the present invention.

FIG. 4 is an exemplary flow chart diagram showing the system for ensuring secure connections between mobile devices and edge devices, according to an embodiment of the present invention.

### DETAILED DESCRIPTION OF PREFERRED EMBODIMENTS

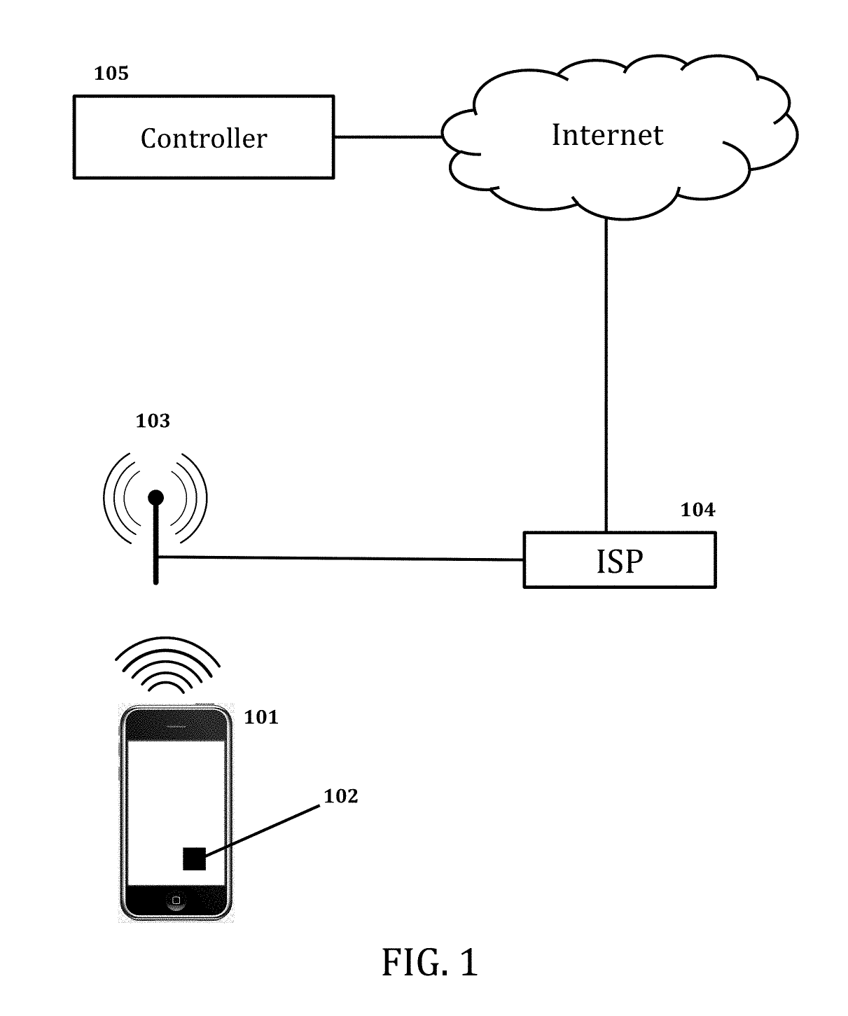

Preferred embodiments of the present invention and their advantages may be understood by referring to FIGS. 1-4, wherein like reference numerals refer to like elements.

The present disclosure details an invention that comprises a system and method for ensuring that a user is connected to a trusted edge device and, once determined to be a trusted connection, the system encrypts data communicated to the mobile device.

In an exemplary embodiment of the present disclosure, the system uses a mobile device and a program loaded thereon, known as an app. The mobile device comprises any device that uses wired or wireless data transmission technology including mobile phones, laptop computers, desktop computers, tablets, I.o.T devices, appliances, and automotive vehicles or their components. The system uses the app to communicate information from the user's mobile device to a controller. The app gathers the device information including device-identifying information such as the device's serial number, the device's model number, and geo-positional locating information such as global positioning satellite (“GPS”) coordinates from the mobile device's hardware and software. The app also gathers information manually entered by the user including a username and password. A user creates a user profile using the app or other device. The system uses the user profile to identify a mobile device and associate it with the user. In another embodiment of the present invention, the system utilizes a subscription-based service to correlate the user and the user's specific devices based on device information including the manufacturer, device model number, device serial number, and other identifying information.

In another exemplary embodiment of the present disclosure, the system utilizes the mobile device's built-in network connectivity such as Wi-Fi to connect to an edge device such as a router, a wireless router, or a modem. The edge device is connected to and provides access to the Internet through an Internet service provider (“ISP”) such as AT&T or Verizon.

In another exemplary embodiment of the present disclosure, the system uses a mobile device and a program loaded thereon, known as an app. In one embodiment, the system allows the mobile device and the app to act as a wireless edge device, wherein other mobile devices can connect to the Internet by tethering to the mobile device.

In another exemplary embodiment of the present disclosure, the system uses a controller to store the user profiles, to generate the user's public and private keys, to evaluate the user's connection information, to generate a custom certificate, and to encrypt and decrypt data transmitted to and received from the mobile device. In one embodiment, the controller can be sored locally as an on-site device. When located on-site, the controller is connected to the edge device directly or though a LAN. In another embodiment of the present invention, the controller can be stored remotely and act as a cloud-based server. When the controller is stored remotely, the system relays information between the app and the controller using the Internet. In another embodiment of the present invention, the controller comprises a plurality of databases that are located at one or more geographic locations with each database able to communicate with the other databases though a LAN or the Internet. In another embodiment of the present disclosure, the controller comprises a cloud-based computing and storage system where the computations performed controller are distributed among one or more computing machines and the data required by the system are stored on one or more devices.

In another embodiment of the present disclosure, the controller also analyzes data gathered by each user and generates analytical reports to be used by the system to improve security and performance.

In another exemplary embodiment of the present disclosure, the system uses the edge device's external Internet protocol address (“IP” address) to determine if the edge device is trusted. It is known in the art that ISPs have specific ranges of external IP addresses that are reserved for public use that are particularized to a specific geographic area and that these ranges are readily available to the public. Further, it is known in the art that replicating a device's external IP address is impossible without hacking into the ISP's internal network. The system determines whether the edge device is trusted by comparing its external IP address to those reserved for public use. The system determines the device is trusted when the edge device's external IP address is consistent with those reserved for public use. The system allows the mobile device to connect to the Internet through the edge device if it is determined to be a trusted connection. The system determines the connection is not trusted when the edge device's external IP address is inconsistent those reserved for public use. The system terminates the connection with an edge device that is not trusted.

In another exemplary embodiment of the present disclosure, the system issues a certificate after the connection between the mobile device and the edge device is determined to be trusted. The system generates the certificate by including aspects of the mobile device including the mobile device's model, the mobile device's serial number, the mobile device's geographic location information, and the user profile. The system generates a new certificate each time a connection is authenticated. The certificate is unique to the mobile device. In another embodiment of the current invention, the system renews the certificate at preset intervals or as needed. In another embodiment of the present disclosure, the certificate uses 2048 bit SSL encryption. In another embodiment of the current invention, the system uses at least a 2048 bit SSL encryption including 4098 bit and higher. In another embodiment of the present invention, the controller acts as a certificate authority that generates the certificate.

In another exemplary embodiment of the present disclosure, the system uses the mobile device's GPS information to authenticate the connection. The system returns a list of near-by connections that have previously been determined to be secure to the app. In another embodiment of the present invention, the system alerts the user when they are near a devices that has previously been determined by the system to not be trusted. In another embodiment of the present disclosure, the app displays near-by trusted edge devices in graphical form including a list, table, or map overlay.

In another exemplary embodiment of the present disclosure, the system retains a logs of devices that are determined to be trusted and not trusted. The log includes the external IP address, geographic location, MAC address, and SSID associated with the connection. The log is stored on the controller. The system does not allow the mobile device to connect to a device that was previously determined to be not trusted and that appears in the log.

In another exemplary embodiment of the present invention, the system is used to secure connections for an Internet of things (“I.o.T.”). I.o.T. is known in the art as the Internetworking of physical devices, vehicles, buildings, or other items that are embedded with electronics, software, sensors, or network connectivity that enable these objects to collect and exchange data. Current market examples include home automation devices such as the control and automation of lighting, heating, ventilation, or air condition systems, and appliances such as clothing washers, clothing dryers, dish washers, robotic vacuums, air purifiers, ovens or refrigerators or freezers that use wireless network connectivity for remote monitoring including Wi-Fi, Bluetooth, infrared, and radio frequency.

In another exemplary embodiment of the present invention and with reference to FIG. 1, the mobile device comprises a cellular telephone 101. The mobile device 101 connects to the edge device 103 using its built-in Wi-Fi connectivity. The edge device 103 comprises a wireless router capable of connecting with the mobile device 101. The edge device 103 is connected to and provides access to the Internet through the Internet service provider (“ISP”) 105. The controller 104 is stored remotely and connected to the Internet. The user of the mobile device 101 installs an app 102 on the mobile device 101. The app on the mobile device 101 communicates with the controller 104 by transmitting data through the mobile device's 101 built-in Wi-Fi connectivity, through the edge device 103, through the ISP 105, and through the Internet. Using the app 102 installed on the mobile device 101, the user creates a profile that is stored on the controller 104. The app 102 collects the device information such as the mobile device's 101 serial number, the device's GPS coordinates, and other information manually entered by the user.

When the user attempts to connect the mobile device 101 to the Internet though an edge device 103, the system determines if the edge device 103 is trusted before allowing any information not related to the authentication process to be transmitted through the edge device 103. The system transmits the device information from the app 102, to the controller 104. The system compares the device information with the user profile. If the device information is inconsistent with the user profile stored on the controller 104, the system determines that the connection is not trusted. The system also reads the edge device's 103 external IP address. The connection with the edge device 103 is determined to be not trusted if the edge device's 103 external IP address is inconsistent with those reserved for public use by the ISP 105. In another embodiment, the system compares the mobile device's 101 GPS location with that of the edge device 103. If the mobile device's 101 GPS location is inconsistent with the edge device's 103 location, the system determines that the connection is not trusted. If the system determines the connection is not trusted, the system terminates the mobile device's 101 connection with the edge device 103. In another embodiment of the present invention, the system sends a notification to the user detailing the terminated connection using an alternative communication means such as text message, SMS message, or email. In another embodiment of the present invention, the system logs the external IP address of the edge device 103 that is not trusted and stores it on the controller 104.

In another exemplary embodiment of the present disclosure, if the system determines that the connection is trusted, the controller 104 issues a certificate to the mobile device 101. The certificate is transmitted from the controller 104 through the Internet, through the ISP 105, through the edge device 103 to the app 102 on the mobile device 101. Once the app 102 receives the certificate, the app 102 allows the mobile device 101 to connect to the edge device 103 and transmit information through the edge device 103. In another embodiment, the system periodically renews the certificate on preset intervals such as every one hour or as needed.

In another exemplary embodiment of the present disclosure, once a connection is determined to be trusted, the system encrypts some or all data communicated to the mobile device 101. The system routes some or all data communicated to the mobile device 101 through the controller 105. The system uses the certificate issued by the controller 104 to encrypt and decrypt data using an encryption bit length of at least 2048 characters. In another exemplary embodiment of the present disclosure, the system uses an encryption bit length of at least 4096 characters to encrypt and decrypt data communicated to the mobile device 101.

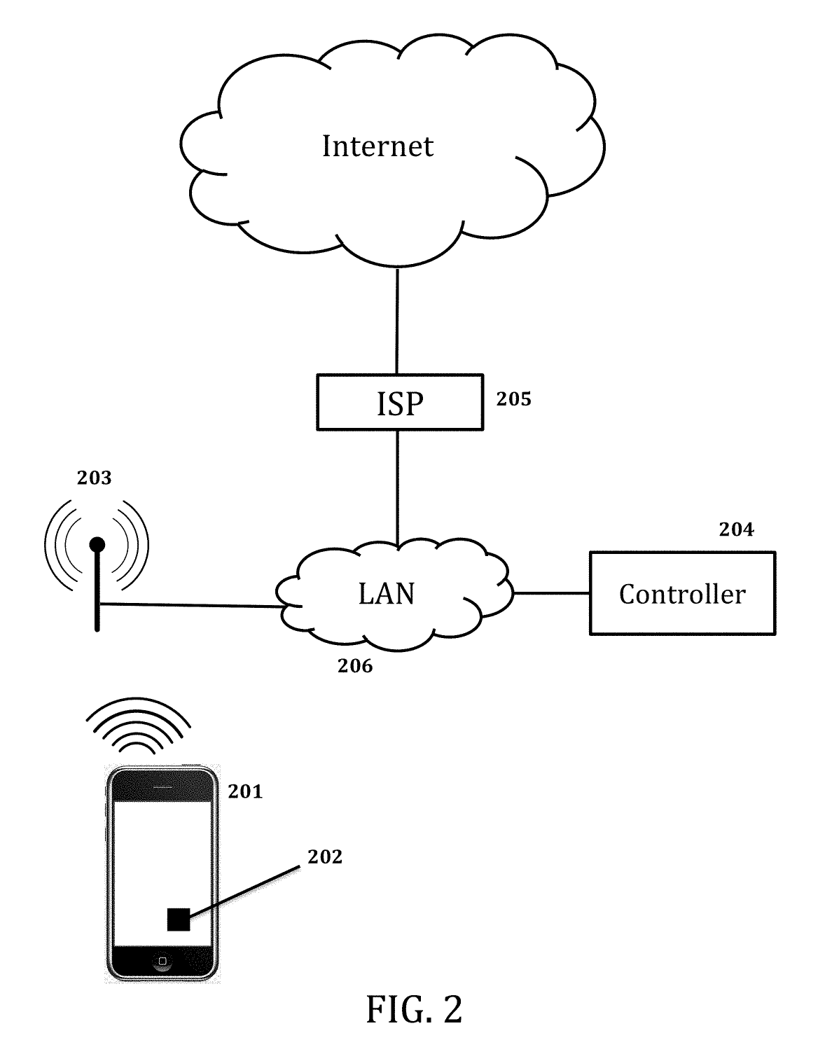

In another exemplary embodiment of the present invention and with reference to FIG. 2, a mobile device 201 comprises a cellular telephone. The mobile device 201 connects to an edge device 203 using its built-in Wi-Fi connectivity. The edge device 203 comprises a wireless router capable of connecting with the mobile device 201. The edge device 203 is connected to a LAN 206. The LAN 206 provides access to the Internet through an ISP 205. a controller 204 is connected to the LAN 206. The user of the mobile device 201 installs an app 202 on the mobile device 201. The app 202 on the mobile device 201 communicates with the controller 204 by transmitting data through the mobile device's 201 built-in Wi-Fi connectivity, through the edge device 203, and through the LAN 206. Using the app 202 installed on the mobile device 201, the user creates a profile that is stored on the controller 204. The app collects the device information such as the mobile device's 201 serial number, the device's GPS coordinates, and other information manually entered by the user.

When the user attempts to connect the mobile device 201 to the Internet though an edge device 203, the system determines if the connection between the edge device 203 and the mobile device 201 is trusted before allowing any information not related to the authentication process to be transmitted through the edge device 203. The system transmits the device information from the app 202, to the controller 204. The system compares the device information with the user profile. If the device information is inconsistent with the user profile stored on the controller 204, the system determines that the connection is not trusted. The system also reads the edge device's 203 external IP address. The connection with the edge device 203 is determined to be not trusted if the edge device's 203 external IP address does not match those reserved for public use by the ISP 205. In another embodiment of the present disclosure, the system compares the mobile device's 201 GPS location with that of the edge device 203. If the mobile device's 201 GPS location is inconsistent with the edge device's 203 location, the system determines that the connection is not trusted. If the system determines the connection is not trusted, the system terminates the mobile device's 201 connection with the edge device 203. In another embodiment of the present invention, the system logs the external IP address of the edge device 203 that is not trusted and stores it on the controller 204.

If the system determines that the connection is trusted, the controller 204 issues a certificate to the mobile device 201. The certificate is transmitted from the controller 204, through the LAN 206, through the edge device 203, to the app 202 on the mobile device 201 or 202. Once the app receives the certificate, the app 202 allows the mobile device 201 to connect to the edge device 203 and transmit information through the edge device 203, through the LAN 206, through the ISP 205, and to the Internet. In another embodiment, the system periodically renews the certificate on preset intervals such as every one hour or as needed.

In another exemplary embodiment of the present disclosure, once a connection is determined to be trusted, the system encrypts some or all data communicated to the mobile device 201. The system routes some or all data communicated to the mobile device 201 through the controller 204. The system uses the certificate issued by the controller 204 to encrypt and decrypt data using an encryption bit length of at least 2048 characters. In another exemplary embodiment of the present disclosure, the system uses an encryption bit length of at least 4096 characters to encrypt and decrypt data communicated to the mobile device 201. The app 202 encrypts and decrypts data using the certificate.

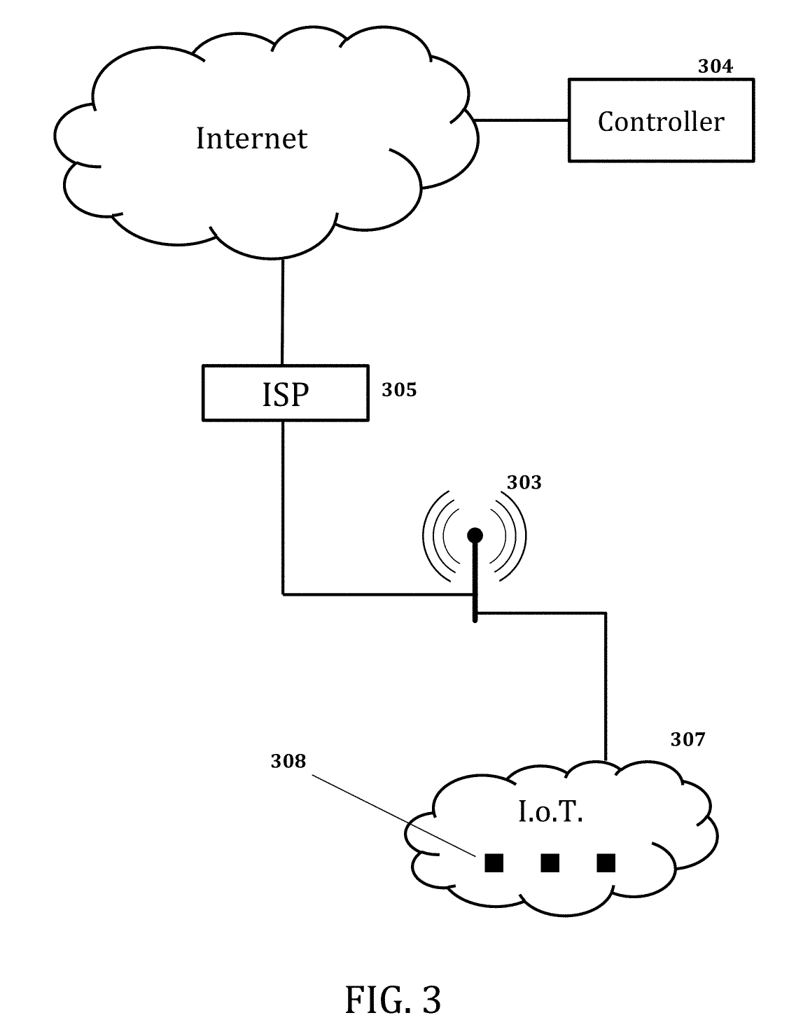

In another exemplary embodiment of the present invention and with reference to FIG. 3, an Internet of things (“I.o.T.”) 307 comprises a plurality of interconnected devices that transmit information between them using wired or wireless connectivity such as Wi-Fi, Bluetooth, infrared, and radio frequency, exemplified by node 308. The I.o.T. 307 is connected to an edge device 303 using its built-in Wi-Fi connectivity. The edge device 303 comprises a wireless router capable of connecting with the I.o.T. 307. The edge device 303 is connected to and provides access to the Internet through an ISP 305. A controller 304 is stored remotely and connected to the Internet. The user or manufacturer of the node 308 installs an app on the node 308. The app on the node 308 communicates with the controller 304 by transmitting data through the edge device 303, through the ISP 305, and through the Internet.

When the node 308 connects to the Internet though an edge device 303, the system determines if the connection with the edge device 303 is trusted before allowing any information not related to the authentication process to be transmitted through the edge device 303. The system transmits the device information from the app, to the controller 304. The system compares the device information with the user profile. If the device information is inconsistent with the user profile stored on the controller 304, the system determines that the connection is not trusted. The system also reads the edge device's 303 external IP address. The connection with the edge device 303 is determined to be not trusted if the edge device's 303 external IP address is inconsistent with those reserved for public use by the ISP 305. If the system determines the connection is not trusted, the system terminates the node's 308 connection with the edge device 303.

If the system determines that the connection is trusted, the controller 304 issues a certificate to the node. 308. The certificate is transmitted from the controller 304 through the Internet, through the ISP 305, through the edge device 303 to the app on the node. 308. Once the app receives the certificate, the app allows the node 308 to connect to the edge device 303 and transmit information through the edge device 303. In another embodiment, the system periodically renews the certificate on preset intervals or as needed.

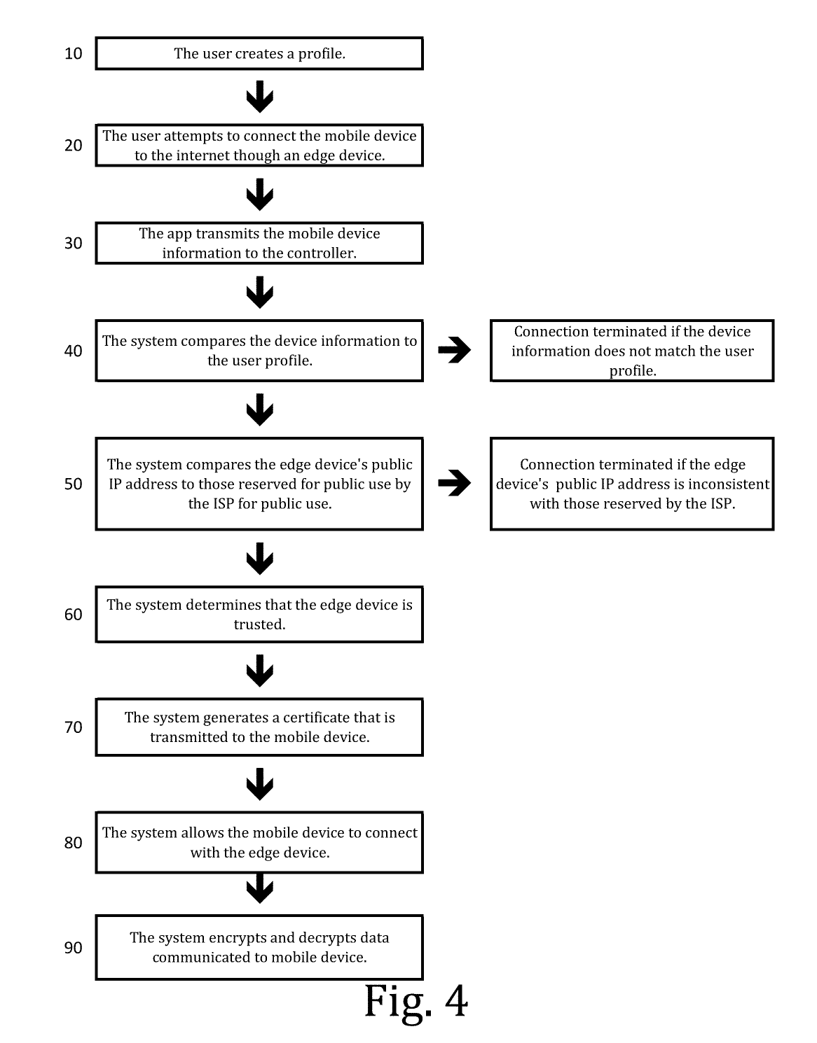

In another exemplary embodiment of the present invention and with reference to FIG. 4, step 10 and step 20, the user creates a user profile that is stored on a controller. The user profile includes device information such the device's serial number and other information manually entered by the user. The system uses a mobile device and a program loaded thereon, known as an app. Once the user has successfully created the user profile, the system issues a temporary key that is sent to the app. When the user attempts to connect the mobile device to the Internet though an edge device such as a wireless access point, the app does not allow the mobile device to transmit any information unrelated to the authentication process to the edge device. In another embodiment of the current invention, the system utilizes a subscription-based model to correlate a user to the user's mobile device.

In another exemplary embodiment of the present invention and with reference to FIG. 4, step 30, the system transmits the device information to the controller using the app. In one embodiment of the present invention, the controller is stored locally. In another embodiment of the present invention, the controller is stored remotely and is accessed through the internet. In another embodiment of the present invention, the controller comprises a plurality of databases stored in one or more geographic locations. The remotely-stored controller serves a cloud-based. The device information is transmitted though the edge device, through the Internet service provider (“ISP”), and through the Internet. The device information includes the device's GPS location, IP address, MAC address, and service set identifier (“SSID”).

In another exemplary embodiment of the present invention and with reference to FIG. 4, step 40, the system compares the device information with the user profile stored on the controller. If the device information is inconsistent with the user profile, the system determines that the connection is not trusted and terminates the connection with the edge device.

In another exemplary embodiment of the present invention and with reference to FIG. 4, step 50, the system compares the edge device's external Internet protocol (“IP”) address to those reserved by the ISP for public use. If the edge device's external IP address is inconsistent with those reserved by the ISP, the system determines that the connection is not trusted and terminates the connection with the edge device. Once the system determines the connection is not trusted, the system prevents any further information from being transmitted over that connection.

In another exemplary embodiment of the present invention and with reference to FIG. 4, step 60, once the system has verified the device information and the edge device's external IP address, the system determines that the connection between the mobile device, the edge device, the ISP and the Internet are trusted.

In another exemplary embodiment of the present invention and with reference to FIG. 4, step 70, once the system has determined the connection to be trusted, the system generates a certificate on the controller and transmits it through the authenticated connection to the mobile device. The system correlates the issued certificate to the user by associating the mobile device's serial number, user account, and GPS location.

In another exemplary embodiment of the present invention and with reference to FIG. 4, step 80, once the app receives the certificate from the controller, the system allows the mobile device to transmit information to the edge device. Once the connection between the mobile device and edge device is broken, the system prevents the mobile device from transmitting any information until the connection is authenticated. In another embodiment of the present invention, the system renews the certificate on present intervals or as needed.

In another exemplary embodiment of the present invention and with reference to FIG. 4, in step 90, the system encrypts and decrypts all or some data communicated to the mobile device. The system routes all or some data communicated to the mobile device though the controller. The system uses the certificate to encrypt and decrypt the data at the controller and at the mobile device.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with this filing.

I claim:

1. A system for ensuring secure connections comprising:
a. a mobile device comprising an electronic device that connects to a network or other device by using wired or wireless connectivity including Wi-Fi, Bluetooth, infrared, radiofrequency, and cellular;
b. a computer-implemented algorithm, wherein the computer-implemented algorithm:
i. is downloaded and installed onto the mobile device;
ii. is utilized by a user to create a username and a password; and
iii. gathers the mobile device's identifying information;
c. an edge device that is directly or indirectly connected to an internet service provider; and
d. a controller comprising:
i. a controller memory;
ii. a central processing unit; and
iii. a certificate authority;
iv. wherein the controller
1. stores the username and the password; and
2. stores the edge device's information on the controller memory.

2. The system of claim 1 wherein the mobile device comprises any electronic device that uses wired or wireless data transmission technology including mobile phones, laptop computers, desktop computers, tablets, internet of things devices, appliances, and automotive vehicles or their components.

3. The system of claim 1 wherein the mobile device's identifying information is selecting from the group consisting of the mobile device's make, model, serial number, external IP address, and geo-location information.

4. The system for ensuring secure connections of claim 1 wherein the certificate authority comprises a program that generates the digital certificate;
a. wherein the certificate authority uses the mobile device's identifying information to create the digital certificate including the mobile device's make, model, serial number, and geo-positional information;
b. wherein the digital certificate contains the mobile device's location information; and
c. wherein the controller periodically renews the digital certificate.

5. The system of claim 1 wherein the controller is stored remotely and comprises one or more databases or one or more servers, wherein the one or more databases or the one or more servers are interconnected and are able to communicate with each other using a local area network or a network.

6. The system of claim 1 wherein the controller is connected to the edge device either directly or through a local area network.

7. The system of claim 1 wherein the mobile device comprises an Internet of things, wherein the Internet of things comprises internetworked physical devices including vehicles, buildings, lighting, heating, ventilation, clothing washers, clothing dryers, dish washers, vacuums, air purifiers, ovens, refrigerators, or other items embedded with electronics, software, sensors, or network connectivity.

8. The system of claim 1 wherein the algorithm is configured to allow other devices to tether to it, thereby allowing the other devices to gain access to a network.

9. The system of claim 1 wherein the certificate authority generates a digital certificate with a minimum bit length of 2048 bits.

10. A computer implemented method for ensuring secure connections comprising the steps of:
a. downloading a computer-implemented algorithm onto a mobile device;
b. creating a username and a password;
c. storing the username and the password on a controller;
d. connecting the mobile device to an edge device;
e. gaining access to a network though an Internet Service Provider to which the edge device is connected;
f. connecting the mobile device to the edge device;
g. connecting the algorithm to the controller though the edge device and the Internet Service Provider;
h. evaluating the edge device's external Internet Protocol address using the controller;
i. wherein the controller instructs the algorithm to terminate the connection if the edge device's external internet protocol address is inconsistent with the Internet Service Provider; and
ii. wherein the computer-implemented algorithm terminates the connection if the edge device's external internet protocol address is inconsistent with the Internet Service Provider;
i. evaluating the edge device's connection information using the controller;
i. wherein the controller instructs the computer-implemented algorithm to terminate the connection if the edge device is associated with another edge device that has previously been determined to be insecure;
j. issuing a digital certificate from the controller;
i. wherein the controller utilizes information to generate the digital certificate including:
1. the mobile device's identifying information;
2. the edge device's make, model, serial number, external IP address and geo-location information; and
3. the ISP's information including external IP address;
k. transmitting the certificate from the controller to the computer-implemented algorithm;
l. routing data through the computer-implemented and the controller;
m. encrypting data at the mobile device and the controller; and
n. decrypting data within the mobile using the computer-implemented algorithm and data within the controller using the certificate.

11. The method of claim 10 wherein the mobile device comprises an electronic device that uses wired or wireless data transmission technology including mobile phones, laptop computers, desktop computers, tablets, I.o.T devices, appliances, and automotive vehicles or their components.

12. The method of claim 10 wherein the controller is stored locally and connected to the edge device though a wired or wireless connection including direct wired connection, a local area network, and Wi-Fi networking connectivity.

13. The method of claim 10 wherein the mobile device's identifying information is selecting from the group comprising the mobile device's make, model, serial number, external IP address, and geo-location information.

14. The method of claim 10 wherein the controller is stored remotely and is connected to the edge device through a network.

15. The method of claim 10 wherein the controller is stored locally or remotely and comprises a plurality of interconnected databases that communicate with each other though wired or wireless means and communicate with the edge device though a network.
